(19) United States
(12) Patent Application Publication
(10) Pub. No.: US 2025/0183943 A1
(43) Pub. Date: Jun. 5, 2025

(54) METHODS, INFRASTRUCTURE EQUIPMENT, RECONFIGURABLE INTELLIGENT SURFACES, RECONFIGURABLE INTELLIGENT SURFACE CONTROLLERS, COMMUNICATIONS DEVICES, AND SYSTEMS

(71) Applicant: Sony Group Corporation, Tokyo (JP)

(72) Inventors: Shin Horng WONG, Basingstoke (GB); Martin Warwick BEALE, Basingstoke (GB); Yassin Aden AWAD, Basingstoke (GB); Vivek SHARMA, Basingstoke (GB)

(73) Assignee: Sony Group Corporation, Tokyo (JP)

(21) Appl. No.: 18/844,066

(22) PCT Filed: Feb. 28, 2023
(86) PCT No.: PCT/EP2023/054941

§ 371 Date: Sep. 5, 2024

(30) Foreign Application Priority Data
Mar. 17, 2022 (EP) 22162755.7

(51) Int. Cl. H04B 7/04; H04B 7/0408; H04B 7/06; H04L 5/00; H04L 25/02; H04W 24/10

(52) U.S. Cl. CPC H04B 7/04013; H04B 7/0408; H04B 7/06952; H04L 5/0048; H04L 25/0224; H04W 24/10

(57) ABSTRACT

A method for operating infrastructure equipment in a wireless communications network is provided. The equipment transmits and receives signals from a communication device and a reconfigurable intelligent surface (RIS). During operation, a signature value associated with the communication device is determined, and one or more beams for signal transmission are selected based on the signature value. The selected beams include a direct beam between the infrastructure and the communication device and beams involving the RIS. The infrastructure equipment controls the RIS configuration to generate these beams, enabling efficient signal transmission between the communication device and the infrastructure.

### BACKGROUND

### Field of Disclosure

The present disclosure relates to methods for the more efficient utilisation of reconfigurable intelligent surfaces (RIS) in wireless communications systems.

The present application claims the Paris Convention priority from European patent application number EP22162755.7, filed on 17 Mar. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current future wireless communications networks, for example those which may be referred to as 5G or new radio (NR) systems/new radio access technology (RAT) systems or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems, as well as future generation communications systems.

The increasing use of different types of network infrastructure equipment, such as base stations and relay nodes/repeater devices, and terminal devices associated with different traffic profiles, as well as the consideration of deployment strategies for such network infrastructure equipment in various and varying environments, together give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating an infrastructure equipment forming part of a wireless communications network, the infrastructure equipment being configured to transmit signals to and/or to receive signals from a communications device and/or to transmit signals to and/or receive signals from a reconfigurable intelligent surface, RIS. The method comprises, during an operational phase, determining a signature value associated with the communications device, selecting, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration the RIS, and transmitting the signal to or receiving the signal from the communications device via the one or more selected beams.

Embodiments of the present technique, which, in addition to methods of operating infrastructure equipment, relate to methods of operating communications devices, to infrastructure equipment, communications devices, circuitry for communications devices, and circuitry for infrastructure equipment, to reconfigurable intelligent surfaces (RIS) and to RIS controllers, to wireless communications systems, to computer programs, and to computer-readable storage mediums, can allow generally for the more efficient transmission and reception of data in wireless communications systems, and particularly for the more efficient transmission and reception of data in wireless communications systems in which RISs are deployed.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates an example of beamforming performed by a gNB;

FIG. 5 illustrates an example of a Reconfigurable Intelligent Surface (RIS) which may be configured to operate in accordance with certain embodiments of the present disclosure;

FIG. 6 illustrates an example of a RIS providing coverage for a user equipment (UE) located in a shadow area;

FIG. 7 illustrates an example of propagation channels that exist between a gNB, a RIS, and a UE;

FIG. 8 shows a part schematic, part message flow diagram representation of a first wireless communications system comprising a RIS, an infrastructure equipment, a RIS controller, and a communications device in accordance with at least some embodiments of the present technique;

FIG. 9 shows a first example of the collection of a data set for a RIS in accordance with embodiments of the present technique;

FIG. 10 shows a first table exemplifying the results of the data set collection performed in the example of FIG. 9 in accordance with embodiments of the present technique;

FIG. 11 illustrates an example of the use of a default RIS parameter used for the purposes of data collection when a UE transmits sounding reference signals (SRS) in accordance with embodiments of the present technique;

FIG. 12 shows a second example of the collection of a data set for a RIS, in which a signature is collected for each RIS beam at a given location, in accordance with embodiments of the present technique;

FIG. 13 shows a second table exemplifying the results of the data set collection performed in the example of FIG. 12 in accordance with embodiments of the present technique;

FIG. 14 illustrates an example of online operation of a gNB and a RIS based on a data set having multiple signatures per location in accordance with embodiments of the present technique; and

FIG. 15 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

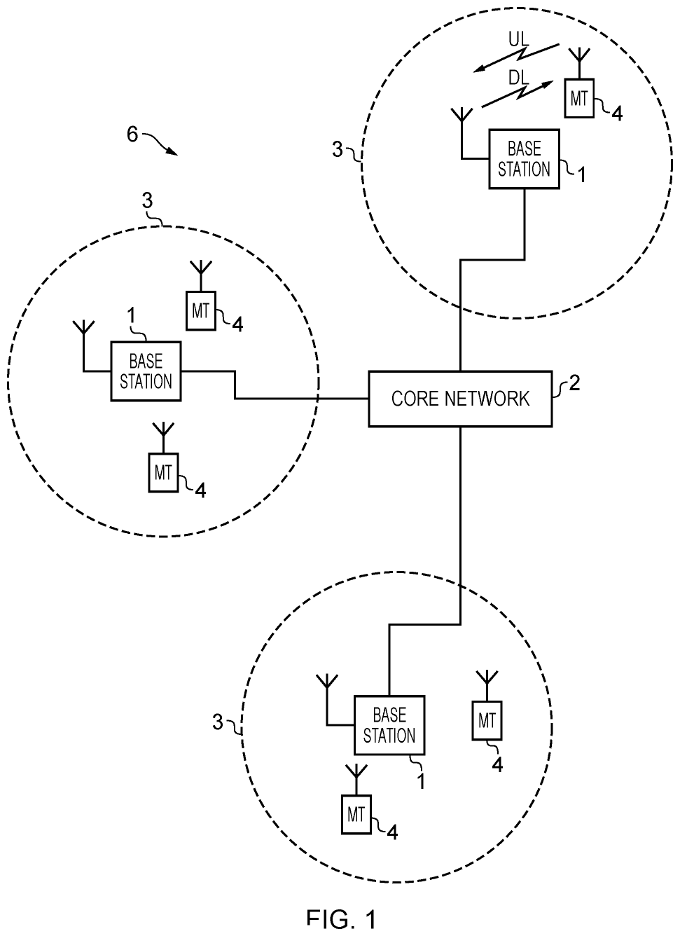

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1].

It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

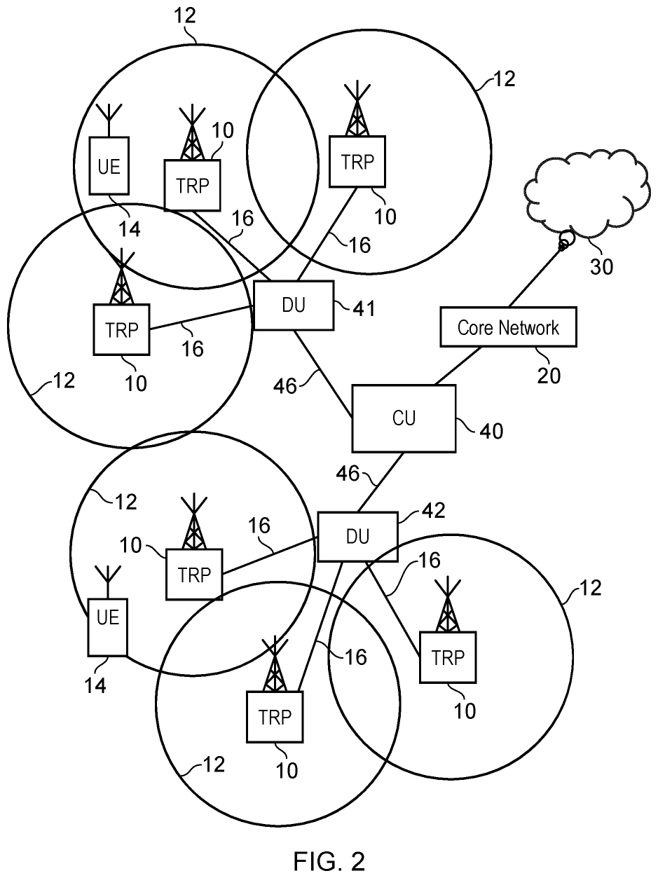

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems.

Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

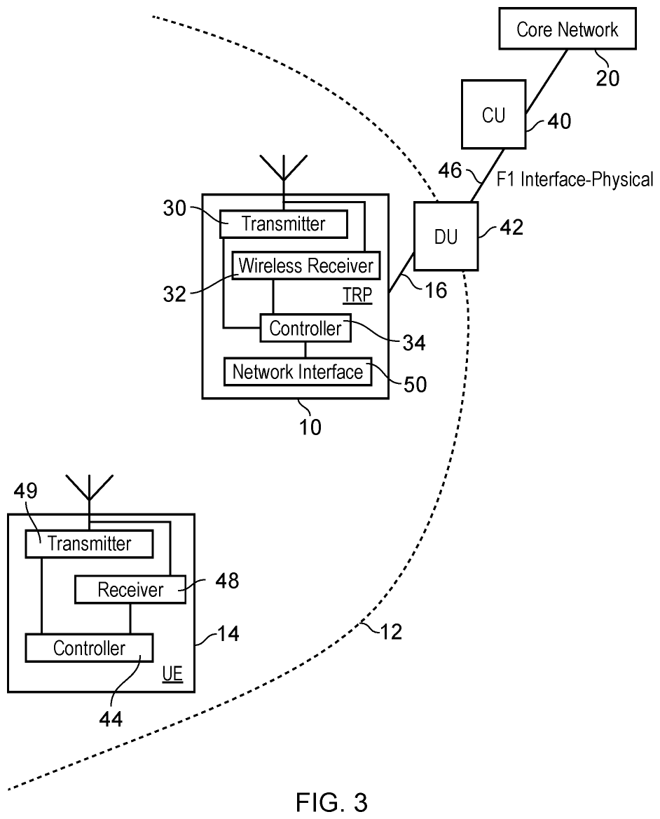

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Beamforming in Wireless Communications Systems

According to some radio access technologies, including NR radio access technologies as exemplified by FIGS. 2 and 3, a geographical cell may be formed (or, in other words, ‘generated’) by a plurality of directional beams. Each beam may be characterised by a variance in gain with respect to a direction from the antenna; a beam may be considered ‘wide’, where the gain is consistently relatively high over a broad range of directions, or ‘narrow’, where relatively high gain is only achieved over a narrow range of directions. A wider beam can be based on synchronisation signal blocks (SSBs) intended for example during initial access (in the RRC_IDLE and RRC_INACTIVE states) while a narrower beam can be formed from channel state information reference signals (CSI-RSs) intended for example for UE-specific beamforming in RRC_CONNECTED state. Depending on the direction of the communications device with respect to the infrastructure equipment, the gain of a particular beam may be sufficiently high (and the resulting coupling loss sufficiently low) to permit communications between the communications device and the infrastructure equipment via the beam. Beams may be formed for transmitting or receiving at the infrastructure equipment using phased antenna arrays, directional antennas, a combination of both, or other known techniques.

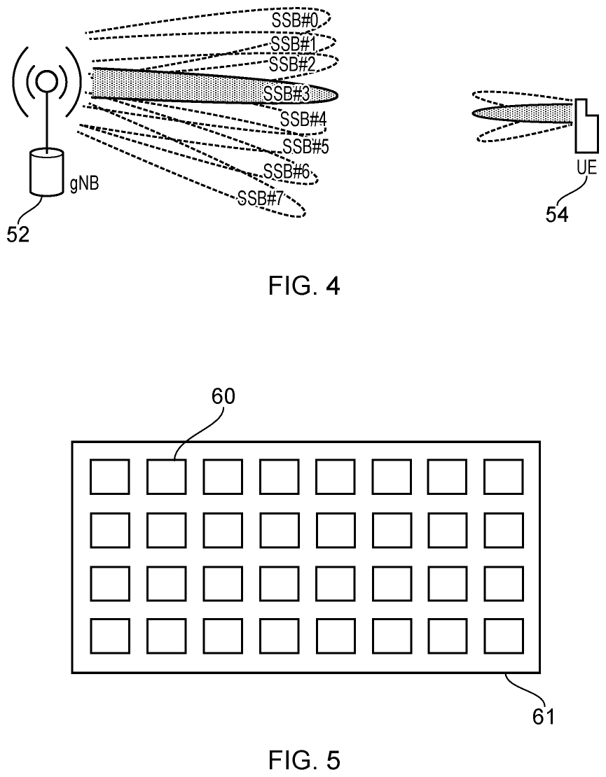

Typically, a gNB will perform beam-sweeping on different directions of a cell, as is shown in FIG. 4. Beam sweeping is where a gNB will activate one or more of a set of beams at a time (i.e. perform transmission or reception in one or more spatial directions at a time) and change these in turn to cover some or all of the set of beams according to predetermined directions and intervals. As can be seen in FIG. 4, the beam based on SSB #3 is activated by gNB 52 for transmitting/receiving signals to/from UE 54; this may have followed SSB #0, SSB #1 and SSB #2 being activated in turn, and may precede each of SSB #4, SSB #5, SSB #6 and SSB #7. Beam sweeping may be applied only to broadcast channels, and a dedicated beam may be applied to a UE in a known direction.

### Reconfigurable Intelligent Surface (RIS)

While useful in a number of different scenarios, beamforming techniques such as those exemplified by FIG. 4 may be inefficient when a gNB is trying to transmit data to and receive data from a UE with which it does not have a clear direct line of sight, no matter the beam being considered. However, simply utilising a relay node for relaying signals between the gNB and UE in accordance with known (e.g. beamforming) techniques would then require successful reception and decoding of the received signal at that relay node, followed by amplification/encoding and subsequent transmission, resulting in increased latency as well as power consumption at that relay node. On the other hand, use of a RIS in such a scenario would be a lower cost solution which introduces less delay, since the RIS simply re-radiates incident signals without having to first decode them, allowing for the realisation of the advantages that beamforming would provide in terms of focusing signal power at a particular location to increase likelihood of successful reception of signals without the drawbacks relating to latency, cost, and power consumption associated with conventional relay nodes. In such situations, a Reconfigurable Intelligent Surface (RIS) can be utilised to re-radiate a signal effectively using beamforming techniques, by changing the electric and magnetic properties of the RIS's surface.

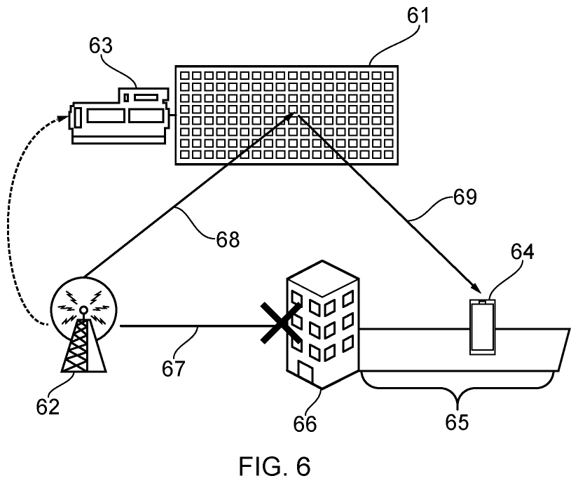

A RIS 61, an example of which is illustrated in FIG. 5, may consist of a surface with N elements 60, where each element can receive a radio wave and reflects, or re-radiates, this radio wave with or without amplification and with a phase shift. The phase shift of each element can be independently configured, or the phase shifts applied to groups of elements can be configured jointly for each those groups of elements. By controlling the phase shifts of these elements, the reflected radio wave can be beamformed, thereby allowing the RIS to redirect the radio wave to a targeted location. Controlling the phase shifts can create a better received signal in both a certain direction and a certain distance from the RIS. Alternatively, the RIS can be configured to control the angle of reflection. Whereas for a “normal” surface, the angle of reflection is equal to the angle of incidence, for a RIS, the angle of reflection can be controlled to be different to the angle of incidence. A RIS may also be known as, for example, a Large Intelligent Surface (LIS) or an Intelligent Reflecting Surface (IRS), and it can be used to enhance coverage in shadow areas, where the radio coverage is weak due to, for example, non-LOS (Line of Sight) between a gNB and a UE. Though the RIS shown in FIG. 6 is rectangular, those skilled in the art would appreciate that a RIS could be any size or shape, and RISs in accordance with embodiments of the present technique are not so limited.

While the RIS 61 of FIG. 5 is shown as comprising a number of RIS elements 60 which are independently configurable, a RIS could instead be of a more analogue form, for example comprising a liquid or malleable material which could be configured so as to change the angle of reflection for example. A RIS may alternatively comprise a plane mirror which is mounted so as that its angle is changeable, or may comprise a bendable or otherwise modifiable mirror, so that in either case incident radio waves get reflected in a different and configurable direction by changing the focal point of the mirror. It will be appreciated that, while having some similar characteristics, a mirror operating at radio frequencies would have a different construction to a mirror operating in the visible spectrum.

An example deployment of a RIS utilised to re-radiate a signal is shown in FIG. 6, where a gNB's 62 downlink (DL) transmissions 67 to a UE 64 are blocked by a building 66; that is, the UE 64 is located in a “shadow” 65 (or “shadow area”) within the gNB's 62 radio coverage. A RIS 61 is deployed in a location that has LOS with the UE 64 in the shadow 65, and the gNB 62 can accordingly direct its DL transmissions 68 to the RIS 61 instead of to the UE 64 such that the gNB's 62 DL transmissions 68 are reflected or redirected 69 by the RIS 61 to the UE 64 in the shadow 65. This thereby enhances the UE's 64 coverage in the shadow area 65. Similarly, UL transmissions from the UE 64 to the RIS 61 may be reflected to the gNB's 62 receiver, thereby allowing the UE 64 to communicate with the gNB 62 despite the building 66 blocking direct transmissions.

The elements of the RIS 61 can be configured independently or in groups, as mentioned above. Effectively, this enables any desirable configuration of the elements to be utilised—for example, different elements or groups of elements re-radiating different transmissions/beams (if, for example, the RIS is large enough. Alternatively, all elements could have a slightly different but carefully selected phase shift such that all focus a beam on a precise common location (e.g. that of a UE 64 in a shadow area 65), or such that they focus a beam on a slightly wider area (with a slightly lower power) in order to provide greater coverage at that area.

A RIS can be deployed in a strategic location to provide coverage in known shadow areas such as shadow area 65 in the example of FIG. 6, and the phase shifts of the elements in the RIS can be configured semi-statically to provide coverage to a known shadow area (which can be thought of as blind/weak spots in the gNB's coverage region). Similarly, where the RIS does not comprise such separate individual elements, the RIS may be deployed as, for example, a reflective mirror or sheet on which a certain pattern is printed, which targets such blind/weak spots in the gNB's coverage region—assuming such blind/weak spots are expected to be permanent or (to at least some degree) semi-permanent. However, such deployment is limiting since there may not be any UEs in the known shadow area. Furthermore, the gNB cell may contain multiple shadow regions, while the shadow regions themselves could potentially be variable (e.g. based on seasonal changes to trees/bushes) or could change overtime (e.g. as new buildings are built). Hence, it is recognised that it would be beneficial for the RIS beam to be directed dynamically rather than semi-statically.

A RIS is typically a passive device, in the sense that it does not itself have a transceiver and cannot therefore decode any received signals or encode any signals for transmission—instead it simply, for example, amplifies and/or phase-shifts incident signals. In order to perform dynamic beamforming, and as shown in the example of FIG. 6, the RIS 61 may be deployed in combination with a RIS controller 63, which may be connected to the gNB 62 or the 5G network such that it can receive instruction from the gNB 62 to direct beams incident at the RIS. The connection between the RIS controller 63 and the gNB 62/5G network can be, for example, an interface such as a cable (if the RIS 61 is nearby to the gNB 62), a microwave link, an IAB link, or a connection using the 5G air interface by implementing a UE receiver within the RIS controller 63 (such that it can decode signalling received from the gNB 62). In an example, wherein a UE receiver is implemented within the RIS controller 63, this signalling to the UE receiver in the RIS controller 63 may be separate to the communication between the gNB 62 and the UE 64 (or any other UE), such that this signalling is not embedded in the communication stream between the gNB 62 and UE 64.

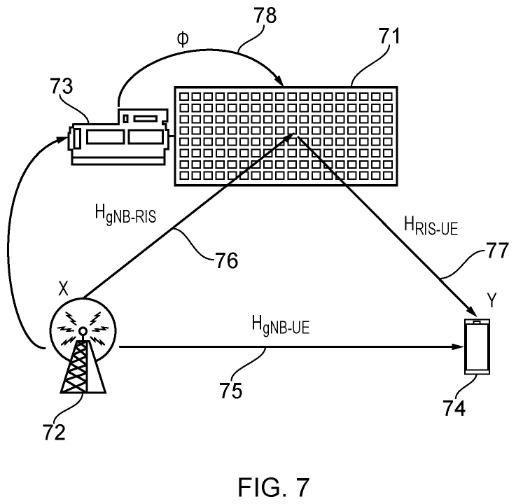

FIG. 7 shows the various possible paths 75, 76, 77 of a radio signal between a gNB 72 and a UE 74 with a deployed RIS 71 (implemented in combination with a RIS controller 73) and these paths 75, 76, 77 can be categorised as follows:
H_{gNB-UE}: The direct propagation channel 75 between the gNB 72 and the UE 74. The term “direct” here means the signal is not reflected via the RIS 71, while the “direct” propagation channel 75 may or may not be LOS;
H_{gNB-RIS}: The propagation channel 76 between the gNB 72 and the RIS 71; and
H_{RIS-UE}: The propagation channel 77 between the RIS 71 and the UE 74.

In the example of FIG. 7, Φ is the matrix of phase shifts [e^{jφ}^{₁} e^{jφ}^{₂} e^{jφ}^{₃} . . . e^{jφ}^{_{N}}], configured by the RIS controller 73 for each of the N elements in the RIS 71, which will determine how the reflected beam is directed. X denotes the DL transmission from the gNB 72 (at the point of transmission from the gNB 72) and Y denotes the received DL signal at the UE 74 after going through one or more of the propagation channels 75, 76, 77. It should be appreciated that although FIG. 7 describes an example in the DL, the description here would also be similarly applicable to the UL, i.e. X can also be an UL transmission from the UE 74 and Y would then be the received signal at the gNB 72. The received signal Y can be expressed in equation [1] below as:

$$Y = X ( {H}_{gNB - RIS} Φ {H}_{RIS - UE} + {H}_{gNB - UE} ) + {N}_{AWGN} \qquad [ 1 ]$$

where N_{AWGN} denotes white noise at the UE's 72 receiver. It can be observed that in addition to the precoding for the transmission in the signal X, the phase shifts required for a desired beam depends on the propagation channels H_{gNB-RIS} and H_{RIS-UE}. The RIS 71, as mentioned above, is a passive device that cannot perform channel estimation, and hence the propagation channels H_{gNB-RIS} and H_{RIS-UE} are not known to the gNB 72. It is therefore difficult for the gNB 72 to determine the required phase shifts Φ at the RIS 71 such that the transmission from the gNB 72 can be beamformed by the RIS 71 to the UE 74 (or to cause the reflection of a beam at the RIS 71 such that it then further propagates in the direction of the UE 74). Those skilled in the art would appreciate that, if the signal X is transmitted directly to the UE 74 by the gNB 72 (and is received as signal Y at the UE 74), then the term H_{gNB-RIS}ΦH_{RIS-UE} of equation [1] above would be 0 or close to 0. Likewise, if the signal X is transmitted by the gNB 72 to the RIS 71 where it is re-radiated to the UE 74 and received as signal Y, then the term H_{gNB-UE} of equation [1] above would be 0 or close to 0. Those skilled in the art would further appreciate that the gNB 72 may try to transmit signal X to the UE 74 via multiple beams (e.g. directly and via the RIS 71, or via separate elements/groups of elements of the RIS 71) in order to increase the likelihood of successful reception of the received signal Y by the UE 74.

In [2], it is proposed that the UE's uplink transmission is performed over two subframes, where the first subframe consists of mostly pilots and the uplink data is transmitted in the second subframe. For the first subframe, the RIS uses a pre-designed or pre-determined set of phase shifts, which enables the gNB to estimate the propagation channels H_{gNB-RIS} and H_{RIS-UE}. The gNB can then determine the appropriate phase shifts Φ for the RIS to direct the beam that maximises the strength of the signal received at the gNB from the UE. It is observed in [2] that for effective channel estimations of H_{gNB-RIS} and H_{RIS-UE}, the number of symbols with pilots, i.e. the duration of the pilot, needs to be equal to the number of elements, which may not be practical for RISs with large numbers of elements. The complexity in channel estimation and pilot resources required are reduced in [2] by grouping the elements into sub-surfaces where each sub-surface consists of a plurality of adjacent elements which share the same phase shift. Here, a sub-surface is treated as a “bigger” element of the RIS. However, sub-surfaces which effectively reduce the flexibility in configuring the phase shifts Φ would also reduce the beamforming ability of the RIS. Furthermore, this method requires a new transmission scheme for the UE, where the UE's transmissions consist of multiple subframes with pilots prior to the data transmission, and so legacy UEs (which had not been deployed with this new transmission scheme) cannot benefit from the targeted beamforming of the RIS. Transmitting multiple subframes that mostly consist of pilots incurs high overheads, and also introduces latency which may not be suitable for low latency traffic for services such as URLLC.

Summarily, a technical problem that is required to be solved with respect to known solutions such as that described in [2] is how to determine the RIS parameters, such as the phase shifts Φ, for a DL or an UL transmission, without incurring high pilot overheads. Embodiments of the present disclosure seek to provide solutions to such a technical problem.

### Dynamic Beamforming for Reconfigurable Intelligent Surface

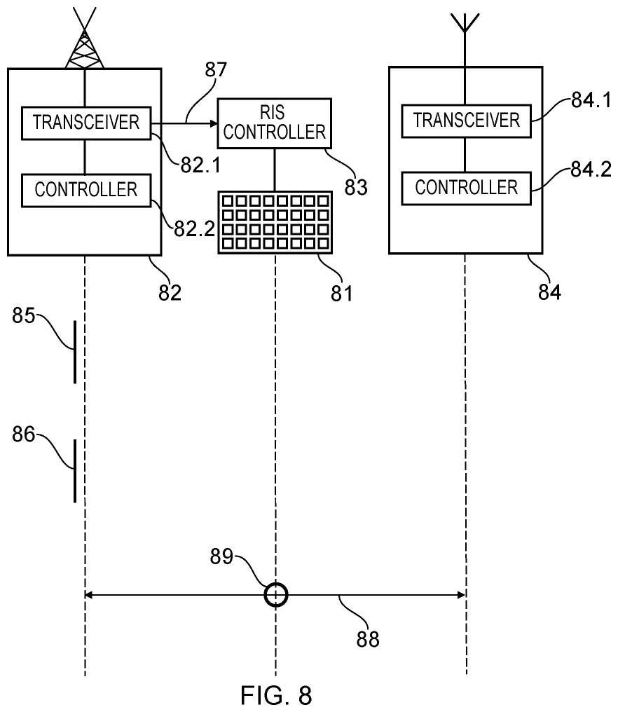

FIG. 8 shows a part schematic, part message flow diagram representation of a first wireless communications system comprising a reconfigurable intelligent surface (RIS) 81, an infrastructure equipment 82, a RIS controller 83 coupled to the RIS 81, and a communications device 84 in accordance with at least some embodiments of the present technique. The communications device 84 is configured to transmit signals to and/or receive signals from the wireless communications network, for example, to and from the infrastructure equipment 82, and to transmit signals to and/or receive signals from the RIS 81. Specifically, the communications device 84 may be configured to transmit data to and/or receive data from the wireless communications network (e.g. to/from the infrastructure equipment 82) via a wireless radio interface provided by the wireless communications network (e.g. the Uu interface between the communications device 84 and the Radio Access Network (RAN), which includes the infrastructure equipment 82), where such signals may first be transmitted (by either the communications device 84 or the network, through, for example, the infrastructure equipment 82) to the RIS 81, at which those signals are re-radiated by the RIS 81 towards (and thus received by) the other of the communications device 84 or the network (e.g. the infrastructure equipment 82). The communications device 84 and the infrastructure equipment 82 each comprise a transceiver (or transceiver circuitry) 84.1, 82.1, and a controller (or controller circuitry) 84.2, 82.2. Each of the controllers 84.2, 82.2 may be, for example, a microprocessor, a CPU, or a dedicated chipset, etc.

As shown in the example of FIG. 8, the transceiver circuitry 82.1 and the controller circuitry 82.2 of the infrastructure equipment 82 are configured in combination, during an operational phase, to determine 85 a signature value associated with the communications device 84, to select 86, based on the signature value 85, one or more of a plurality of beams for the transmission of a signal between the infrastructure equipment 82 and the communications device 84, each of the plurality of beams being associated with one of a plurality of possible signature values, wherein at least one of the plurality of beams is a direct beam between the infrastructure equipment 82 and the communications device 84 and at least one other of the plurality of beams is a beam between the communications device 84 and the RIS 81 (referred to herein as a “RIS beam”), wherein each of the at least one of the plurality of beams between the communications device 84 and the RIS 81 are generated at the RIS 81 through controlling, by the infrastructure equipment 82 (e.g. by transmitting control signals/signalling information 87 to the RIS controller 83), a configuration of the RIS 81 (e.g., where such configuration of the RIS 81 may include, but is not limited to, a phase shift configuration and/or an amplitude configuration—and this configuration may be a configuration of a plurality of RIS elements of the RIS 81 where the RIS 81—such as that shown in the example of FIG. 8—comprises such a plurality of RIS elements), and to transmit 88 the signal to or to receive 88 the signal from the communications device 84 via the one or more selected beams 86.

Where the RIS 81 does not comprise such a plurality of RIS elements as shown in the example of FIG. 8 (or, indeed, even if it does), the configuration of the RIS may comprise one or more of: controlling, by the infrastructure equipment, a configuration of the plurality of RIS elements of the RIS (e.g. the phase shift or amplitude of these elements either individually, in combination, or in sub-groups for example), controlling, by the infrastructure equipment, an amount by which the RIS is bent, controlling, by the infrastructure equipment, an amount by which the RIS is rotated, controlling, by the infrastructure equipment, a size of a reflection angle of the RIS, and controlling, by the infrastructure equipment, a focal length of the RIS.

As those skilled in the art would appreciate, such transmission 88 or reception 88 shown in FIG. 8 may involve—dependent on the selected beam 86—through indication of the circle 89, either a direct transmission or reception using the direct beam as the selected beam 86, or a transmission to the RIS 81 by either the infrastructure equipment 82 or communications device 84, where the signal is re-radiated by the RIS 81 such that it is then received by the other of the infrastructure equipment 82 or the communications device 84. Furthermore, multiple beams may be utilised for the transmission 88 or reception 88 of the signal, where such multiple beams may comprise multiple RIS beams or one or more RIS beams in combination with the direct beam. As indicated, the signal may be a downlink signal that is transmitted 88 by the infrastructure equipment 82 to the communications device 84 (directly and/or via the RIS 81) or the signal may be an uplink signal that is received 88 by the infrastructure equipment 82 from the communications device 84 (directly and/or via the RIS 81). The communications device 84 may determine therefore the beam to use for the transmission which is received 88 by the infrastructure equipment 82 based on receiving signalling information from the infrastructure equipment 82 which may explicitly or implicitly indicate that beam. Alternatively, the communications device 84 may in some implementations (where it determines and signals the signature value) be aware of the association between the signature values and the beams, and so is able to select the beam itself with little or no instruction from the infrastructure equipment 82. As those skilled in the art would further appreciate, when a RIS beam is used for the transmission of a signal from the infrastructure equipment 82 to the communications device 84 or vice versa, a beam between the infrastructure equipment 82 and the RIS 81 (where there may be either one or a plurality of such beams) is used in combination with this RIS beam, so as to form a path with the RIS beam between the infrastructure equipment 82 and the communications device 84 via the RIS 81.

Essentially, embodiments of the present technique propose that a gNB is able to configure the RIS parameters for a RIS in a dynamic fashion, where the RIS parameters are determined from an association between a signature and a beam (referred to herein as a “signature-beam association”). The signature may describe (i.e. may be a representation of) the receiver's radio channel conditions, and the signature may be used as an input to the signature-beam association to determine the most appropriate beam that provides the best signal at the receiver dependent on that signature. The appropriate beam can be a direct beam from the gNB or UE to the other of the gNB and UE, or can be a beam between the RIS and the UE, that may be a reflection of a beam transmitted by the gNB. Determining such RIS parameters dynamically in this manner, for example as described with reference to the example of FIG. 8, will allow for signalling between the UE and gNB to be reduced (e.g. in terms of overheads related to pilots being essentially removed), and will therefore allow for the more efficient transmission of data since more time/resources will be used for the actual data transmission.

Broadly speaking, the signature-beam association is constructed (thus, for example, forming a look-up table) via a training process (also referred to herein as the training phase) where measurements from multiple UE locations are performed to form one or more data sets. In each location, one or more signatures representing the radio conditions between the gNB and the UE are measured, and for each signature, the strongest beam (which can be from the RIS or can be a direct transmission from the gNB) is determined; i.e. a beam is paired with a signature, resulting in the construction of a data set consisting of multiple pairs of signatures and beams. This training process can be performed offline or during off-peak hours (e.g. middle of the night), and would ideally be performed only once, or at limited (periodic or aperiodic intervals). For example, if performance loss is observed by the network, or if there are any significant topology changes at locations between the UE and the gNB (e.g. a tree is chopped down, or a building is built), then the training process might be carried out again.

Once the training process is completed and a signature-beam association is formed, in the online operation (also referred to herein as the operational phase), the gNB either measures a signature or receives feedback of a signature measured by the UE, which represents the UE's radio conditions, and finds a match using the signature-beam association information to dynamically determine the most appropriate RIS parameters, e.g. phase shifts CD, to configure the RIS elements to use that would provide the best beam between the RIS and the UE (or indeed directly between gNB and UE) for the UE to receive signals from and/or to transmit signals to the gNB. Such determination of a signature (and therefore best beam) for a UE may be performed directly before transmission of data by or to that UE, so as to determine the best beam, but for reasonably static or UEs with limited mobility patterns, such signature (and therefore beam) determination may be performed further in advance of any data transmissions, for example when the UE enters a connected or inactive state for the first time with a particular gNB, or the UE moves into a particular shadow area within which a RIS is deployed. Such signature (and therefore beam) determination may also be performed in a periodic manner for such UEs.

The signature represents the radio propagation conditions between the UE and the gNB, which depends on the location of the UE. The signature is used during the training process, i.e. the offline phase, when performing measurements with respect to the potential beams in order to determine the best beam for use based on any particular signature. This signature is also used during the online/operational phase when user data is transmitted so as to select that best beam.

In some arrangements of embodiments of the present technique, the signature may be the channel estimation, such as the channel delay profile of the receiver. In other words, the signature value is a channel estimation of a communications channel between the infrastructure equipment and the communications device. For example:
The channel estimation at the gNB's receiver can be determined from sounding reference signals (SRS) or physical random access channel (PRACH) transmissions from the UE—in other words, the channel estimation is performed by the infrastructure equipment based on signals transmitted by the communications device to the infrastructure equipment, where such signals may be reference signals and/or random access signals; or
The channel estimation at the UE's receiver can be determined using CSI-RS or other RS (reference signals/reference symbols) transmitted by the gNB—in other words, the channel estimation is performed by the communications device based on signals received by the communications device from the infrastructure equipment.

Since channel estimation is part of the receiver's decoding process, the gNB and UE can each easily extract the channel delay profile without consuming significant resources for the transmission/reception of pilot or reference signals. The channel estimation can be obtained from existing RS, such as SRS, PRACH, CSI-RS, etc, and so legacy UEs—for which such RS are defined—can benefit from the signature-RIS beam association defined in accordance with embodiments of the present technique as well as newly-deployed UEs. The channel delay profile can then be used as input to the signature-RIS beam association to determine the strongest or most appropriate RIS beam or beams for DL and/or UL transmissions with the UE. Since channel estimation is performed at the physical layer, the gNB can obtain the signature very quickly, which is beneficial for a UE that is moving quickly.

In some other arrangements of embodiments of the present technique, the signature may be the signal strength, e.g. RSRP, of the serving gNB and its neighbouring cell(s). In other words, the signature value is the measured strength of one or more signals received by the communications device from the infrastructure equipment and/or measured strength of one or more signals received by the communications device from one or more other infrastructure equipment (i.e. neighbouring infrastructure equipment). The combination of different RSRPs may depend on the UE location relative to all its neighbouring cells and can therefore act as a signature that represents the UE's location and radio condition, where this signature can then be associated with a preferred beam. It should be noted that, while potentially advantageous in other respects, signal strength measurements such as RSRP are radio resource control (RRC)-level measurements, and the RRC measurement reports which carry them may have a slower update rate compared to using channel estimation.

In some such arrangements of embodiments of the present technique, the signature may be the signal strength of the neighbour cells relative to the serving cell. In other words, the signature value may be the measured strength of the one or more signals received by the communications device from the one or more other infrastructure equipment relative to the measured strength of the one or more signals received by the communications device from the infrastructure equipment. In an example, this can be the RSRP of each neighbour cell relative to the RSRP of the serving cell.

In other arrangements of embodiments of the present technique, the signature may be the signal strength, e.g. RSRP, of sidelink signals. In other words, the signature value may be the measured strength of one or more sidelink signals received by the communications device from one or more nodes of the wireless communications network. For example, some fixed transmitters transmit sidelink signals, such as roadside units (which may include traffic lights, pedestrian crossings etc).

In other arrangements of embodiments of the present technique, the signature may be the time of arrival (or time difference of arrival) of signals from the serving cell and neighbouring cells. In other words, the signature value may be associated with either: a time of arrival at the communications device of signals received by the communications device from the infrastructure equipment and/or signals received by the communications device from one or more other infrastructure equipment, or a difference between the time of arrival and a time of transmission of the signals by the infrastructure equipment and/or the signals by the one or more other infrastructure equipment. The signals for which the time difference of arrival is measured could include the SSB, positioning reference signals (PRS), CSI-RS or other reference signals. It should be noted that the set of time differences can be used as a signature even if the geographic location (as could be calculated by a location server according to arrangements such as those discussed in the following paragraph below) associated with those time differences is not known. The set of time differences of signals from multiple cells can be considered to form a unique signature. The time of arrival of such signals may be explicitly (or implicitly) indicated by the UE in signalling such as uplink control information (UCI)—in other words, the infrastructure equipment may be configured to receive, from the communications device, an indication of the time of arrival at the communications device of signals received by the communications device from the infrastructure equipment and/or signals received by the communications device from one or more other infrastructure equipment. Where the signature relates to the difference between the time of arrival and a time of transmission of the signals by the serving cell and/or the signals by the one or more neighbouring cells, while the gNB knows the time of transmission of its own signals to the UE, it may need to receive some sort of indication of such times of transmission of signals from the neighbouring cells to the UE. In other words, the infrastructure equipment may be configured to receive, from the one or more other infrastructure equipment, an indication of a time of transmission of the signals by the one or more other infrastructure equipment. However, the infrastructure equipment doesn't necessarily need to know the transmission timing from the other infrastructure equipment. Provided the transmission timing of the signals from the other infrastructure equipment doesn't change relative to the transmission timing of the infrastructure equipment in question, the reception timing of the signals used for time difference measurement (e.g. SSB, PRS etc) can be used as a signature.

In other arrangements of embodiments of the present technique, the signature may be the geographic location (e.g. latitude/longitude) of the UE. The geographic location can be obtained from the UE's internal global navigation satellite system (GNSS) receiver or by using a mobile assisted network positioning system such as Observed Time Difference Of Arrival (OTDOA). Positioning is typically not managed by the gNB but by a location server (which is located in the network separately from the gNB). That is, the geographic location would generally need to be sent to a location server, and then this information would be passed back to the gNB by the location server to be used as a signature. Hence, while potentially advantageous in other respects, using geographic location as a signature may have a slower update rate compared to signal strength measurements and channel estimation should this need to go via the location server. However, in some arrangements, the location information could be transmitted from the UE directly to the gNB, which would allow for its use as a signature to be used more advantageously than scenarios in which the location server acts as an intermediary.

In other arrangements of embodiments of the present technique, the signature may be a set of radiofrequency samples that are taken by the gNB or UE. In other words, the signature value may be a set of samples taken by the infrastructure equipment based on signals received by the infrastructure equipment from the communications device, or the signature value may be a set of samples taken by the communications device based on signals received by the communications device from the infrastructure equipment, and the infrastructure equipment may therefore be configured to receive, from the communications device, an indication of the set of samples. These samples can relate to a known signal or set of symbols that have been transmitted by one of the entities. For example, the UE can transmit an SRS signal and the gNB can take a set of analogue to digital conversion (ADC) samples of the received signal containing the SRS. This set of ADC samples can then be used as a signature that can be used for the signature-RIS beam association, since the sampled signal provides an indication of the location of the UE in the sense that it will be different for any given position at which the UE is located when the UE transmits or receives those SRS. It should be noted that channel estimation does not therefore need to be performed to derive the signature in such arrangements.

As mentioned above, the signature-beam association is essentially constructed via a training process (also referred to herein as the training phase) where measurements from multiple UE locations are performed to form one or more data sets. The training phase consists of two steps therefore; the data set collection, and the formation of the signature-beam association. In other words, the infrastructure equipment is configured to operate in accordance with a training phase prior to the operational phase, wherein the infrastructure equipment is configured, during the training phase, to determine the plurality of possible signature values of the communications channel between the infrastructure equipment and the communications device, to perform, for each of the plurality of signature values, measurements using each of the plurality of beams, and to create, based on the performed measurements, associations between the plurality of signature values and the plurality of beams.

The data set may be built by collecting measurements of signatures, such as channel estimations, RSRP measurements or GPS/geographic locations (as described above), and pairing those signatures with a beam (which may be one of the beams from the RIS or may be the direct gNB beam). This paired beam generally is the one that gives the strongest signal (where such a signal may be transmitted by either of the gNB or the UE), e.g. SNR. In other words, the infrastructure equipment is configured, for each of the plurality of signature values, to either transmit a signal to the communications device or to receive a signal from the communications device via each of the plurality of beams, and to determine a strength of either the received signal at the infrastructure equipment or the transmitted signal at the communications device.

The data set may be collected at multiple locations in the cell served by the gNB and the RIS. In other words, the infrastructure equipment may be configured to perform the training phase a plurality of times, wherein, during each of the times the training phase is performed, the communications device has a different geographic location.

These pairs of signatures (e.g. channel estimation) and strongest beam measurements form the data set used to construct an algorithm to enable the signature-RIS beam association. In other words, the infrastructure equipment is configured to determine, for each of the plurality of signature values, the beam of the plurality of beams for which the transmitted/received signal has the highest strength, wherein the association is created between that signature value and the beam for which the transmitted/received signal has the highest strength for that signature value.

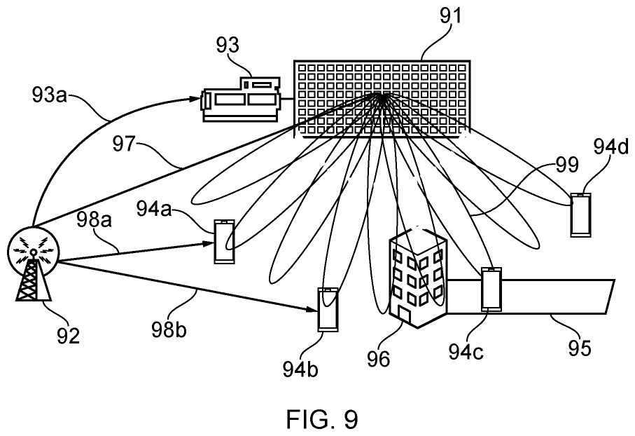

FIG. 9 shows an example data set collection process where measurements are collected over K locations 94a, 94b, 94c, 94d across the gNB's 92 cell coverage. Though four locations (94a, 94b, 94c, 94d) are shown in FIG. 9, this is just an example, and the skilled person would appreciate that K could essentially take any number. Likewise, though one location (i.e. 94c) is shown as being located in a shadow area 95 caused by a building 96, any number of the locations may or may not be located in one or more shadow areas. The gNB 92 may be able to communicate with UEs by utilising direct beams 98a, 98b, or by utilising a number of possible RIS beams 99 effectively created via re-radiation of signals transmitted directly 97 from the gNB 92 and incident on the RIS 91. The RIS 91 may be, as described above, coupled to a RIS controller 93, which is controlled via signals 93a transmitted by the gNB 92.

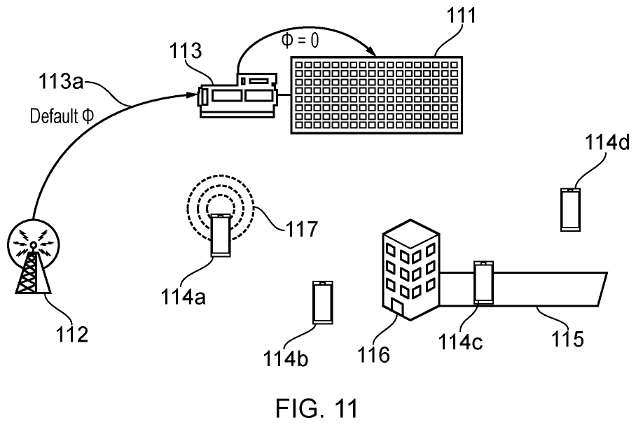

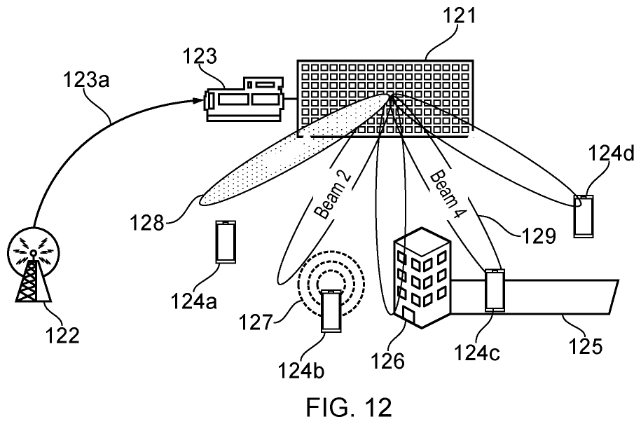

In the example of FIG. 9, the gNB 92 operates in time division duplexing (TDD) mode and in each location 94a, 94b, 94c, 94d:
The UE transmits a series of SRS (though those skilled in the art would appreciate that the transmission here could be a transmission other than SRS, such as PRACH);
   When the UE transmits the SRS, the RIS 91 may be set to a default/known configuration. Since the RIS 91 can passively change the propagation channel (by changing how signals are reflected though control signals 93a from the gNB 92 transmitted to the RIS controller 93), it is useful for the signature to be derived with a known and constant reflection status of the RIS 91. This aspect is discussed further with reference to FIGS. 11 and 12 below;
The gNB 92 uses the received SRS (or PRACH) for channel estimation, thereby producing a signature for each location 94a, 94b, 94c, 94d;
The gNB 92 then transmits one or more DL transmissions using a direct beam 98a, 98b to the UE. The gNB 92 may choose beamforming weights to transmit the beam to the UE by various means that are known by skilled artisans, such as weights based on the channel estimation results derived from the SRS. The UE then measures the received (average) SNR, i.e. SNR_{Direct}; and
The gNB 92 then transmits multiple DL transmissions to the RIS 91 and sweeps the RIS beams 99 (i.e. Beam 1 to Beam 9 as shown in FIG. 9—though any number of RIS beams 99 could of course be used) and for each RIS beam 99, the UE measures the received SNR. The UE then determines the RIS beam 99 (and/or indeed direct beam 98a, 98b) with the strongest SNR, i.e. SNR_{RIS} and records that beam (in terms of its association with a certain determined signature).

Here, considering it is expected that signatures will typically (though not always) be unique for each location, if the gNB produces a signature that it has logged before, it will assume it already has knowledge of the best beam for a particular location (i.e. the beam associated with that already-logged signature). In such a case, the gNB will only need to transmit DL signals using its direct beam and RIS beams to the UE so as to determine the best beam when it derives a signature that it has not logged before. In other words, the infrastructure equipment may be configured to carry out the steps of performing, for each of the plurality of signature values, measurements using each of the plurality of beams, and the creating, based on the performed measurements, associations between the plurality of signature values and the plurality of beams, only when a determined signature value is determined by the infrastructure equipment to be different to any previously determined signature values.

In some arrangements, because it is possible that a signature might not be unique for a particular location, the gNB may determine a second type of signature (for example, using RSRP measurements rather than the SRS channel estimation as described above). Here, the gNB is then able to associate both the already-logged SRS signature and the new RSRP signature with the same best beam. In other words, the infrastructure equipment may be configured to determine that one of the determined signature values is the same as a previously determined signature value, to determine a second signature value, the second signature value being a different type of signature to the one of the determined signature values, and to create, based on the performed measurements, the association between both the determined signature value and the second signature value and one of the plurality of beams.

In a similar scenario, because it is possible that a signature might not be unique for a particular location, the gNB may determine a best beam in one location and a different best beam in a second location are both associated with the same non-unique signature. In such a case, the gNB may then again determine a second type of signature at the second location (and optionally, at the first location too) to associate in combination with the first non-unique signature and the different best beams. In other words, the infrastructure equipment may be configured to determine that one of the determined signature values is the same as a previously determined signature value, to create, based on the performed measurements, the association between the determined signature value and the one of the plurality of beams, to determine that the previously determined signature value is associated with a different one of the plurality of beams to the determined signature value, to determine a second signature value, the second signature value being a different type of signature to the one of the determined signature values, and to create, based on the performed measurements, the association between both the determined signature value and the second signature value and one of the plurality of beams.

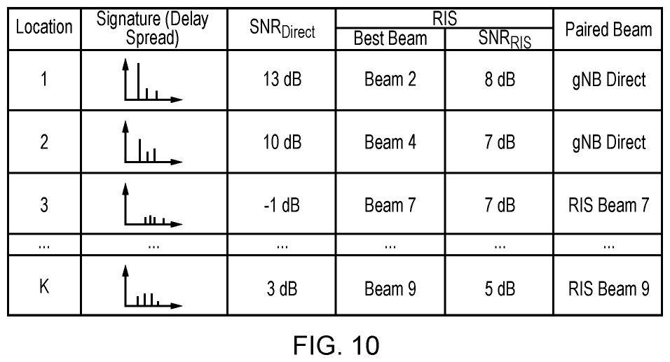

An example of the collected data set for the example in FIG. 9 is shown in the table of FIG. 10. In this example, the channel delay profile for Location 1 (corresponding to location 94a of FIG. 9) obtained from the UE's SRS transmissions shows a strong direct beam 98a, giving SNR_{Direct}=13 dB, and the best beam from the RIS 91 is Beam 2, giving an SNR_{RIS}=8 dB. Since the gNB 92 direct beam 98a to the UE gives a stronger signal than the best RIS beam (Beam 2), the paired beam for the signature in Location 1 is the gNB's 92 direct beam 98a. For Location 3, (corresponding to location 94c in FIG. 9), the UE is blocked by the building 96 and therefore does not have line-of-sight with the gNB 92 and its signature has a very weak or no direct path. For Location 3, the measured SNR_{Direct}=−1 dB whilst the best RIS beam, Beam 7, gives an SNR_{RIS}=7 dB. Therefore, the paired beam for the signature in Location 3 is RIS Beam 7. This pairing of signature with beam is performed for all of the measured locations 94a, 94b, 94c, 94d, thereby producing the data set.

The example in FIG. 9 operates in TDD mode, which makes use of channel reciprocity where the channel estimation performed at the gNB's receiver from the UE SRS transmission is also applicable for DL transmission from the gNB. It should be appreciated that the present invention is applicable also for frequency division duplexing (FDD) mode, where here the UE may report the channel estimation to the gNB for the gNB to form the data set.

In some arrangements of embodiments of the present technique, the signature (e.g. channel estimation) in each measurement location is determined using default RIS parameters, i.e. a known set of phase shifts (D. In other words, the infrastructure equipment may be configured to determine the plurality of possible signature values associated with the communications device whilst maintaining a default configuration of the plurality of RIS elements.

Using the measurements in FIG. 9, when the UE is transmitting SRS, the gNB 92 can for example set Φ=0 for all elements in the RIS 91. Once the gNB 92 obtains the channel estimation, it can then set Φ to the values that would produce Beam 1, Beam 2, etc, so as to measure the signal strength using each of these beams at each of the measurement locations 94a, 94c, 94c, 94d. Such arrangements recognise that the RIS parameters, i.e. the phase shifts Φ (and/or amplitude modifications) would affect the propagation channel and hence would affect the signature using channel estimation at the receiver. For signatures using channel estimation (or a set of RF samples for example) as a signature to determine the best beam for a transmission, it is therefore important that the gNB is aware of the phase shifts of the RIS configured when this signature was derived. It should be appreciated by those skilled in the art that signatures related to GPS/geographic locations (or time difference measurements) may be independent of the RIS beam setting, as the channel conditions are unrelated or at least have little effect on the determined signatures.

An example of the utilisation of default RIS parameters for the determination of signatures is shown in FIG. 11, where, like the example of FIG. 9, measurements are collected over K locations 114a, 114b, 114c, 114d across the gNB's 112 cell coverage. Though four locations (114a, 114b, 114c, 114d) are shown in FIG. 11, this is just an example, and the skilled person would appreciate that K could essentially take any number. Likewise, though one location (i.e. 114c) is shown as being located in a shadow area 115 caused by a building 116, any number of the locations may or may not be located in one or more shadow areas. The RIS 111 may be, as described above, coupled to a RIS controller 113, which is controlled via signals 113a transmitted by the gNB 112.

In the example of FIG. 11, measurements for a signature in Location 1 (i.e. location 114a) are collected, and here the gNB 112 configures (via control signalling 113a transmitted to the RIS controller 113) the RIS 111 to a set of default parameters (e.g. sets Φ=0) so that the gNB 112 knows the condition of the RIS 111 when determining the signature values. The default RIS parameters are used for all other locations 114b, 114c, 114d too, i.e. Location 2, Location 3, . . . , Location K. When the network is online, i.e. not in training mode, the gNB 112 can set the RIS 111 to use the default parameters when the gNB 112 is receiving SRS 114b transmitted by the UE or the when gNB 112 is transmitting RS to the UE such that the UE is able to perform channel estimation to determine signatures for the signature-beam association. It should be noted here that the gNB 112 may ask the UE to perform SRS transmissions for purposes other than for the determining of signatures for the signature-beam association. It should also be appreciated that the default RIS parameters can relate to other settings than Φ=0 for all elements, as long as the gNB 112 knows which RIS settings are the default settings and these are consistent (or at least adjusted for) when determining the signatures at each location 114a, 114b, 114c, 114d.

In some arrangements of embodiments of the present technique, multiple signatures (e.g. channel estimations) are measured, one for each RIS beam configuration. In other words, the infrastructure equipment may be configured to perform the determination of the plurality of possible signature values associated with the communications device a plurality of times, for each of a different configuration of the plurality of RIS elements, to produce a plurality of sets of the plurality of possible signature values. Such arrangements allow the RIS, during online operation, to use a beam for a first UE at the same time as a second UE is transmitting SRS (or receiving CSI-RS) for the purpose of determining the signature.

An example of such arrangements is shown in FIG. 12, where, like the examples of FIGS. 9 and 11, measurements are collected over K locations 124a, 124b, 124c, 124d across the gNB's 122 cell coverage. Though four locations (124a, 124b, 124c, 124d) are shown in FIG. 12, this is just an example, and the skilled person would appreciate that K could essentially take any number. Likewise, though one location (i.e. 124c) is shown as being located in a shadow area 125 caused by a building 126, any number of the locations may or may not be located in one or more shadow areas. The RIS 121 may be, as described above, coupled to a RIS controller 123, which is controlled via signals 123a transmitted by the gNB 122.

In the example of FIG. 12, the gNB 122 is operating in TDD mode, and measurements are currently being collected in Location 2 (i.e. location 124b). Here, the UE in Location 2 starts transmitting SRS 127, and the gNB 122 sets the RIS 121 to transmit Beam 1 whilst performing channel estimation for this setup, where the signature is logged as S_{Beam1}. The gNB 122 will then change the RIS beam to Beam 2 and collects another signature S_{Beam2} and so on until RIS Beam 5 (or all the beams being considered for training, which may be fewer than or more than five beams). The gNB 122 then determines the best beam for the UE in Location 2 (i.e. location 124b), and in this case for example it would be a direct gNB beam. The gNB 122 then proceeds to the next location, Location 3 (i.e. location 124c), and performs the same thing for each RIS beam until the procedure reaches Location K. It should be appreciated that while the example of FIG. 12 uses five RIS beams to simplify the description of the process shown, a larger number of beams may be used for data set collection in accordance with arrangements of embodiments of the present technique.

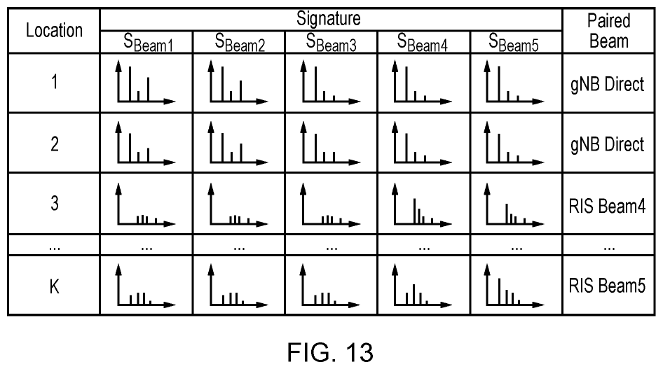

An example data set collected using such arrangements as described with respect to the example of FIG. 12 is shown in the table of FIG. 13. Here in each location, five signatures—each corresponding to a RIS beam used for training—are collected as shown in FIG. 12, and these signatures are paired with a single beam that provides the best signal at the UE.

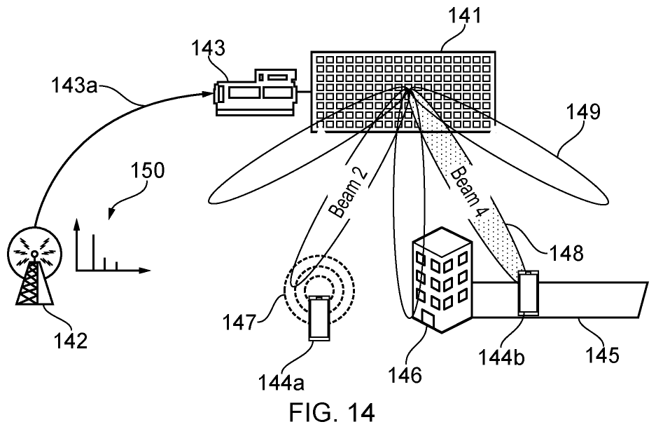

An example online (operational phase) operation using the data set in the table of FIG. 13 is shown in FIG. 14, where a gNB 142 operates in TDD mode. The gNB 112 schedules a second UE 144b, which is in a shadow 145 created by a building 146, to transmit uplink data and configures the RIS 141 (via control signalling 143a transmitted to the RIS controller 143 coupled to the RIS 141) to use Beam 4 148 from among the possible RIS beams 149, thereby benefiting from the reflection of the RIS 141 in the shadow area 145. At the same time, the gNB 142 schedules a first UE 144a to transmit SRS 147 so that it can determine a signature for the first UE 144a and therefore determine an appropriate beam for DL transmissions. The gNB 142 performs channel estimation using the first UE's 144a SRS 147, and since it is aware that the RIS 141 is set to Beam 4 148, the gNB 142 will use the signature-beam association to look up (or otherwise determine via algorithm or the like as described herein) the signatures obtained when Beam 4 148 is used, i.e. under the “S_{Beam4}” column in the table of FIG. 13, to find a signature that matches the channel estimation it performed on the first UE 144a. In this example, the first UE's 144a signature has a close match with the signature under S_{Beam4} for Location 2 as indicated in the table of FIG. 13, and therefore the best beam for this signature is a direct beam from the gNB 142. The gNB 142 then transmits directly to the first UE 144a using a direct beam rather than using the RIS 141 (i.e. rather than utilising any of the re-radiated RIS beams 149).

In some arrangements of embodiments of the present technique, different data sets are collected for the downlink and the uplink transmissions. Such arrangements recognise that in FDD, the downlink and uplink channels are not reciprocal and therefore separate data sets are required. In other words, the infrastructure equipment may be configured to perform the training phase separately for downlink transmissions and uplink transmissions. For signatures using channel estimation (or RF samples), the uplink channel estimation is performed at the gNB using the UE's SRS or PRACH transmissions. In the downlink, the UE performs the channel estimation using RS from the gNB such as CSI-RS, etc, and feeds back the channel estimates to the gNB. The pairing of the best beam may also be done separately for the UL and DL. For signatures using RSRP, GPS/geographic location, or time differences, the signatures can each be determined once since they will be the same in the DL and the UL, but the beam pairing step is then required to be carried out separately for the DL and UL.

It should also be noted that the nine and five RIS beams considered for data set collection in the examples in FIGS. 9 and 12 respectively are used to simplify the explanation of arrangements of embodiments of the present technique. In actual deployments, more RIS beams may be used. The more beams that are considered, the better the data set is, and therefore the better the gNB can determine the appropriate beam for a given UE's location. However, as the skilled person would understand, this would also make the data set more complex, and both the time taken to construct it during the training phase and the time taken to determine a beam for a signature using the signature-beam association may therefore be greater.

It should be appreciated that although the examples described herein utilised channel estimation as the signature, other signatures such as RSRP and GPS/geographic locations as described in accordance with arrangements of embodiments of the present technique can of course be used for the data set collection process instead.

In some arrangements of embodiments of the present technique, the signatures from the UE are post-processed in order to provide a derived value. That derived value is then associated with a beam. In other words, the infrastructure equipment may be configured, when determining the plurality of possible signature values associated with the communications device, to perform a post-processing procedure on the plurality of possible signature values. As an example, the power delay profile that is produced as a result of channel estimation can be compared to the power delay profiles that would be expected from a ray tracing model of the deployment at different locations within the ray tracing model. The derived value is then a location that is derived from the ray tracing model. It should be noted that it doesn't particularly matter whether the location derived from the ray tracing model is the actual location of the UE. All that is required here is a mapping between the derived values and the best beams.

In the above examples, it is assumed that there is a single best beam associated with a signature. In general however, there can be multiple beams associated with a signature. For example, there are some locations (i.e. signatures) where a significantly improved SNR can be obtained if the UE is served by both the direct beam from the gNB and a reflected beam from the RIS, or if the UE is served by beams from two RIS, i.e. RIS1 and RIS2. Hence, in some arrangements of embodiments of the present technique, the data set may comprise a set of beams with each signature. For example, in the table of FIG. 10, UE location 2 may be associated with both the gNB direct beam and RIS beam 4, since there is an SNR difference of only 3 dB between these beams. It should be noted that, in this example, for location 2, if RIS beam 4 did not significantly add to the SNR, it may not be worth using both the gNB direct beam and RIS beam 4 for that location. Hence in some arrangements of embodiments of the present technique, an additional beam is associated with a signature only if it improves the SNR by more than a threshold amount.

It is possible that there is more than one appropriate beam corresponding to a signature, for example, the gNB direct beam and a RIS beam may offer the same SNR (or similar SNR) at the UE in a location. In other words, the infrastructure equipment may be configured to determine that the transmitted/received signals have the highest strength for a particular signature value when transmitted/received via each of two or more of the plurality of beams. Hence, to cater for this, in some arrangements of embodiments of the present technique, when two or more beams produces similar SNR, the following implementations can be used:
If one of the beams is a gNB direct beam, the gNB direct beam is selected if it is either stronger or is the same strength as the strongest RIS beam—in other words, the infrastructure equipment may be configured to determine, if the two or more of the plurality of beams comprise the direct beam between the infrastructure equipment and the communications device, that the direct beam between the infrastructure equipment and the communications device is to be associated with that signature value;
If one of the beams is a gNB direct beam, the gNB direct beam is selected if it is within a threshold amount T_{Beam} from the strongest beam. For example if the SNR for the direct beam is SNR_{Direct}=9 dB and the SNR for RIS Beam K is SNR_{RIS}=10 dB and T_{Beam}=2 dB, then the gNB direct beam may be selected, since SNR_{Direct}+T_{Beam}>SNR_{RIS}—in other words, the infrastructure equipment may be configured to determine that the transmitted/received signals have a strength within a predetermined threshold of the highest strength when transmitted/received via at least one other of the plurality of beams. Here, the infrastructure equipment may then determine, if the beam for which the transmitted/received signal has the highest strength for that signature value is a beam between the communications device and the RIS and the at least one other of the plurality of beams comprises the direct beam between the infrastructure equipment and the communications device, that the direct beam between the infrastructure equipment and the communications device is to be associated with that signature value instead of the beam for which the transmitted/received signal has the highest strength for that signature value;
If at least one other beam (either a RIS beam or the direct beam) is within a threshold amount T_{Beam} from the strongest beam (which also may be either a RIS beam or the direct beam), or indeed if a RIS beam has the same strength as the direct beam and the direct beam is considered to be the strongest beam, then the gNB may determine that such a beam or beams within that threshold may be recorded as a backup beam, should there be any issues (e.g. a change in channel conditions or a defect with respect to one or more RIS elements or data congestion on one of the beams) that prevents the strongest beam from being used for a certain paired signature—in other words, the infrastructure equipment may be configured to determine that the at least one other of the plurality of beams is also to be associated with that signature value as a backup beam to the beam for which the transmitted/received signal has the highest strength for that signature value; and
If all the beams are from the RIS, and they have the same SNR, then the first indexed beam may be selected—in other words, the infrastructure equipment may be configured to determine, if the two or more of the plurality of beams are all beams between the communications device and the RIS, that the one of the two or more of the plurality of beams associated with a lowest index is to be associated with that signature value.

Such arrangements as those described above, where there is more than one appropriate beam corresponding to a signature, for example, the gNB direct beam and a RIS beam may offer the same SNR (or similar SNR) at the UE in a location, can allow for the saving of power and/or latency (e.g. by utilising direct beams when this is as good as or within a certain threshold of the best RIS beam), and may also—if a direct beam is used instead of a RIS beam—free up the RIS elements for re-radiating signals via RIS beams to other UEs which may need to receive signals via RIS beams more, such as UEs located in shadow areas.

The UE may alternatively signal all beams that have an SNR within T_{Beam} of the direct beam. This would lead to one signature being associated with multiple potential beams. This would allow the gNB to make better decisions on which beam to use to service UEs within its coverage area. For example, if there are two UEs that need to be scheduled in the coverage area, where:
UE_A is associated with both a direct beam with SNR_{Direct}=9 dB and a RIS beam with SNR_{RIS}=10 dB; and
UE_B is associated only with one RIS beam (and is not associated with any direct beam).

In this example, the gNB could service UE_A with the direct beam and could service UE_B with the RIS beam at the same time. This would mean that UE_B could be serviced via the RIS and UE_A could still receive service that is good enough (if UE_A had been serviced by the RIS, it would have received a more robust signal but UE_B could not have been scheduled).

It can be observed that there is essentially an infinite (or at least, a very large) number of possible signatures, and depending on the number of elements comprised by the RIS, there can also potentially be a very large number of possible RIS beams. The data set collection therefore may be just a fraction of all possible signature-beam matches. That is, the data set is a statistical representation of the possible combinations of signatures and beams. Hence, an algorithm for the signature-beam association may be required so that, during the online operational phase, the signature (such as channel estimation obtained at the gNB for a specific UE) can be used as an input to the algorithm used for the signature-beam association to determine an appropriate beam for the transmission.

In some arrangements of embodiments of the present technique, the algorithm for the signature-beam association may be developed using Machine Learning. The data set is used as training data where during an inference phase, the input is the recorded signatures and the output is the paired beams; during a training phase, the training data set comprises matched pairs of recorded signature and paired beam. In other words, during the operational phase, the selecting the selected beam based on the signature value may comprise performing a machine learning algorithm, the signature value being an input to the machine learning algorithm and the selected beam being an output of the machine learning algorithm. During the training phase, the infrastructure equipment may be configured to train the machine learning algorithm by matching, as an input to the machine learning algorithm, each of the determined signature values with, as an output to the machine learning algorithm, the associated beam of the plurality of beams.

In other arrangements of embodiments of the present technique, the algorithm for the signature-beam association may be a lookup table where each entry contains a signature for a known RIS parameter and the paired beam. In other words, the selecting the selected beam based on the signature value may comprise using a look-up table to select the selected beam based on an association between the selected beam and the signature value defined in the look-up table. The channel estimates or RSRP measurements for a UE are obtained during online operation and they are used by the gNB to find the closest match to a signature in the lookup table to determine the beam for its transmission.

In other arrangements of embodiments of the present technique, a signature determined by the gNB may not be unique, i.e., there may be different locations in the cell which have a similar signature. In this case, a gNB may associate a signature to multiple beams, and as a result the transmission may be duplicated via multiple beams as the gNB does not exactly know which beam the UE is located in. In other words, two or more of the plurality of beams are associated with the signature value, and the infrastructure equipment may be configured to select, based on the signature value, each of the two or more of the plurality of beams that are associated with the signature value for the transmission of a signal between the infrastructure equipment and the communications device, and to transmit the signal to or receiving the signal from the communications device via each of the two or more selected beams.

Similarly, in such a case where the signature is not unique, as described above with respect to the example data set collection of FIG. 9, the gNB may determine a second type of signature for a certain location. Here, the gNB is then able to associate both an already-logged first signature and the new second signature (where these signatures are of different types) with the same best beam. In other words, the infrastructure equipment may be configured to determine that one of the determined signature values is the same as a previously determined signature value, to determine a second signature value, the second signature value being a different type of signature to the one of the determined signature values, and to create, based on the performed measurements, the association between both the determined signature value and the second signature value and one of the plurality of beams.

In a similar scenario, where a signature is not unique for a particular location, the gNB may determine a best beam in one location and a different best beam in a second location are both associated with the same non-unique signature. In such a case, the gNB may then again determine a second type of signature at the second location (and optionally, at the first location too) to associate in combination with the first non-unique signature and the different best beams. In other words, the infrastructure equipment may be configured to determine that one of the determined signature values is the same as a previously determined signature value, to create, based on the performed measurements, the association between the determined signature value and the one of the plurality of beams, to determine that the previously determined signature value is associated with a different one of the plurality of beams to the determined signature value, to determine a second signature value, the second signature value being a different type of signature to the one of the determined signature values, and to create, based on the performed measurements, the association between both the determined signature value and the second signature value and one of the plurality of beams.

During online operation, the gNB needs to obtain the signature from the UE so that it can be fed into the signature-beam association algorithm to determine an appropriate beam, i.e. either a RIS beam or the gNB's direct beam, for its or for the UE's transmissions. Some signalling is required in some implementations (i.e. those where the UE determines its own signature or provides certain measurements/signals to the gNB for it to determine the UE's signature) so that the gNB can obtain the signature during the training process and also during online operations.

For TDD operation, where the signature is the channel estimation, the gNB can use the legacy SRS or PRACH transmission from the UE to obtain the signature. In other words, the channel estimation is performed by the infrastructure equipment based on signals (e.g. reference signals or PRACH transmissions) received by the infrastructure equipment from the communications device. Due to channel reciprocity, this signature can be used for UL and DL transmissions. Hence no new signalling is required for this operation, which is particularly advantageous.

In some arrangements of embodiments of the present technique, where the signature is a collection of signal strengths from different cells, a new measurement report consisting of a list of cells is introduced.
In an implementation of such arrangements, the measurement report consists of RSRPs from a list of configured neighbouring cells—in other words, the infrastructure equipment may be configured to receive, from the communications device, a measurement report comprising an indication of the measured strength of the one or more signals received by the communications device from the infrastructure equipment and/or the measured strength of the one or more signals received by the communications device from the one or more other infrastructure equipment;
In another implementation of such arrangements, the measurement report consists of RSRPs of a list of configured neighbouring cells relative to the RSRP of the serving cell—in other words, the infrastructure equipment is configured to receive, from the communications device, a measurement report comprising an indication of the measured strength of the one or more signals received by the communications device from the infrastructure equipment relative to the measured strength of the one or more signals received by the communications device from the one or more other infrastructure equipment; and
In another implementation of such arrangements, the measurement report consists of sidelink RSRP and the ID of the element where that RSRP is received from, e.g. an element can be a traffic light, pedestrian crossing, sign post, etc—in other words, the infrastructure equipment is configured to receive, from the communications device, a measurement report comprising an indication of the measured strength of the one or more sidelink signals received by the communications device from the one or more nodes of the wireless communications network and an indication of an identifier of each of the one or more nodes of the wireless communications network.

In other arrangements of embodiments of the present technique, the UE feedbacks its channel estimations, e.g. based on CSI-RS or DMRS, to the gNB. In other words, the infrastructure equipment may be configured to receive, from the communications device, an indication of the channel estimation performed by the communications device. Here, the signals transmitted by the infrastructure equipment to the communications device for the communication device to perform the channel estimation may be channel state information reference signals and/or demodulation reference signals. Such arrangements are beneficial for DL transmission in an FDD operation since there is no channel reciprocity for FDD.

In some such arrangements of embodiments of the present technique, the channel estimation feedback from the UE may be quantized, e.g. to P number of paths. In other words, the indication of the channel estimation performed by the communications device is received as a quantized indication of the channel estimation. Quantizing the channel estimation feedback is beneficial if the channel estimation feedback is performed at the physical layer as typically there is limited capacity for control channel feedback in PUCCH.

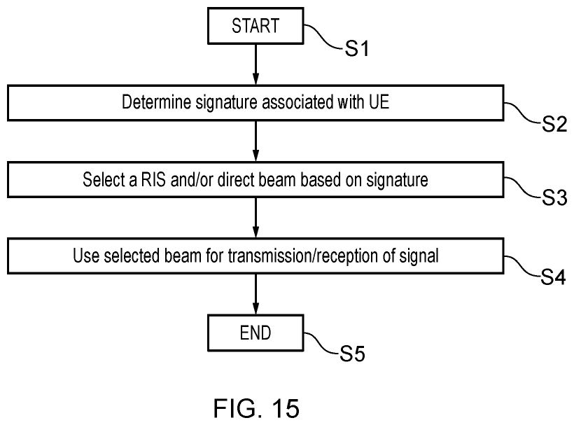

FIG. 15 shows a flow diagram illustrating an example process of communications in a communications system in accordance with embodiments of the present technique. The process shown by FIG. 15 is a method of operating an infrastructure equipment forming part of a wireless communications network, the infrastructure equipment being configured to transmit signals to and/or to receive signals from a communications device and/or to transmit signals to and/or receive signals from a reconfigurable intelligent surface, RIS.

The method of FIG. 15, which is performed during an operational phase, begins in step S1. The method comprises, in step S2, determining a signature value associated with the communications device. In step S3, the process comprises selecting, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS. Then, in step S4, the method comprises transmitting the signal to or receiving the signal from the communications device via the one or more selected beams. The process ends in step S5.

Those skilled in the art would appreciate that the method shown by FIG. 15 may be adapted in accordance with embodiments of the present technique. For example, other intermediate steps may be included in this method, or the steps may be performed in any logical order. Though embodiments of the present technique have been described largely by way of the example communications system shown in FIG. 8, and described with respect to the operation examples defined by FIGS. 9 to 14, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating an infrastructure equipment forming part of a wireless communications network, the infrastructure equipment being configured to transmit signals to and/or to receive signals from a communications device and/or to transmit signals to and/or receive signals from a reconfigurable intelligent surface, RIS, the method comprising, during an operational phase,
determining a signature value associated with the communications device,
selecting, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS, and
transmitting the signal to or receiving the signal from the communications device via the one or more selected beams.

Paragraph 2. A method according to Paragraph 1, wherein the signature value is a channel estimation of a communications channel between the infrastructure equipment and the communications device.

Paragraph 3. A method according to Paragraph 2, wherein the channel estimation is performed by the infrastructure equipment based on signals received by the infrastructure equipment from the communications device.

Paragraph 4. A method according to Paragraph 3, wherein the signals, received from the communications device and based on which the channel estimation is performed by the infrastructure equipment, are reference signals and/or random access signals.

Paragraph 5. A method according to any of Paragraphs 2 to 4, wherein the channel estimation is performed by the communications device based on signals transmitted by the infrastructure equipment to the communications device.

Paragraph 6. A method according to Paragraph 5, comprising receiving, from the communications device, an indication of the channel estimation performed by the communications device.

Paragraph 7. A method according to Paragraph 6, wherein the indication of the channel estimation performed by the communications device is carried in Uplink Control Information, UCI, received from the communication device.

Paragraph 8 A method according to Paragraph 6 or Paragraph 7, wherein the indication of the channel estimation performed by the communications device is received in a Physical Uplink Control Channel, PUCCH, from the communication device.

Paragraph 9. A method according to any of Paragraphs 6 to 8, wherein the indication of the channel estimation performed by the communications device is received as a quantized indication of the channel estimation.

Paragraph 10. A method according to any of Paragraphs 5 to 9, wherein the signals transmitted by the infrastructure equipment to the communications device for the communication device to perform the channel estimation are channel state information reference signals and/or demodulation reference signals.

Paragraph 11. A method according to any of Paragraphs 1 to 10, wherein the signature value is a measured strength of one or more signals received by the communications device from the infrastructure equipment and/or measured strength of one or more signals received by the communications device from one or more other infrastructure equipment.

Paragraph 12. A method according to Paragraph 11, comprising
receiving, from the communications device, a measurement report comprising an indication of the measured strength of the one or more signals received by the communications device from the infrastructure equipment and/or the measured strength of the one or more signals received by the communications device from the one or more other infrastructure equipment.

Paragraph 13. A method according to Paragraph 11 or Paragraph 12, wherein the signature value is the measured strength of the one or more signals received by the communications device from the one or more other infrastructure equipment relative to the measured strength of the one or more signals received by the communications device from the infrastructure equipment.

Paragraph 14. A method according to Paragraph 13, comprising
receiving, from the communications device, a measurement report comprising an indication of the measured strength of the one or more signals received by the communications device from the one or more other infrastructure equipment relative to the measured strength of the one or more signals received by the communications device from the infrastructure equipment.

Paragraph 15. A method according to any of Paragraphs 1 to 14, wherein the signature value is a measured strength of one or more sidelink signals received by the communications device from one or more nodes of the wireless communications network.

Paragraph 16. A method according to Paragraph 15, comprising
receiving, from the communications device, a measurement report comprising an indication of the measured strength of the one or more sidelink signals received by the communications device from the one or more nodes of the wireless communications network and an indication of an identifier of each of the one or more nodes of the wireless communications network.

Paragraph 17. A method according to any of Paragraphs 1 to 16, wherein the signature value is associated with a time of arrival at the communications device of signals received by the communications device from the infrastructure equipment and/or signals received by the communications device from one or more other infrastructure equipment.

Paragraph 18. A method according to Paragraph 17, wherein the signature value is a difference between the time of arrival and a time of transmission of the signals by the infrastructure equipment and/or the signals by the one or more other infrastructure equipment.

Paragraph 19. A method according to Paragraph 17 or Paragraph 18, comprising
receiving, from the communications device, an indication of the time of arrival at the communications device of signals received by the communications device from the infrastructure equipment and/or signals received by the communications device from one or more other infrastructure equipment.

Paragraph 20. A method according to Paragraph 19, comprising
receiving, from the one or more other infrastructure equipment, an indication of a time of transmission of the signals by the one or more other infrastructure equipment.

Paragraph 21. A method according to any of Paragraphs 1 to 20, wherein the signature value is a geographic location of the communications device.

Paragraph 22. A method according to any of Paragraphs 1 to 21, wherein the signature value is a set of samples taken by the infrastructure equipment based on signals received by the infrastructure equipment from the communications device.

Paragraph 23. A method according to any of Paragraphs 1 to 22, wherein the signature value is a set of samples taken by the communications device based on signals received by the communications device from the infrastructure equipment, and the method comprises
receiving, from the communications device, an indication of the set of samples.

Paragraph 24. A method according to any of Paragraphs 1 to 23, wherein the selecting the one or more selected beams based on the signature value comprises performing a machine learning algorithm, the signature value being an input to the machine learning algorithm and the one or more selected beams being an output of the machine learning algorithm.

Paragraph 25. A method according to any of Paragraphs 1 to 24, wherein the selecting the one or more selected beams based on the signature value comprises using a look-up table to select the one or more selected beams based on an association between the one or more selected beams and the signature value defined in the look-up table.

Paragraph 26. A method according to any of Paragraphs 1 to 25, wherein two or more of the plurality of beams are associated with the signature value, and the method comprises
selecting, based on the signature value, each of the two or more of the plurality of beams that are associated with the signature value for the transmission of a signal between the infrastructure equipment and the communications device, and
transmitting the signal to or receiving the signal from the communications device via each of the two or more selected beams.

Paragraph 27. A method according to any of Paragraphs 1 to 26, wherein the method comprises a training phase prior to the operational phase, wherein the method comprises, during the training phase,
determining the plurality of possible signature values of the communications channel between the infrastructure equipment and the communications device,
performing, for each of the plurality of signature values, measurements using each of the plurality of beams, and
creating, based on the performed measurements, associations between the plurality of signature values and the plurality of beams.

Paragraph 28. A method according to Paragraph 27, wherein the performing the measurements comprises, for each of the plurality of signature values
either transmitting a signal to the communications device or receiving a signal from the communications device via each of the plurality of beams, and
determining a strength of either the received signal at the infrastructure equipment or the transmitted signal at the communications device.

Paragraph 29. A method according to Paragraph 28, wherein the creating the associations between the plurality of signature values and the plurality of beams comprises
determining, for each of the plurality of signature values, the beam of the plurality of beams for which the transmitted/received signal has the highest strength, wherein the association is created between that signature value and the beam for which the transmitted/received signal has the highest strength for that signature value.

Paragraph 30. A method according to Paragraph 28 or Paragraph 29, comprising
determining that the transmitted/received signals have the highest strength for a particular signature value when transmitted/received via each of two or more of the plurality of beams.

Paragraph 31. A method according to Paragraph 30, comprising
determining, if the two or more of the plurality of beams comprise the direct beam between the infrastructure equipment and the communications device, that the direct beam between the infrastructure equipment and the communications device is to be associated with that signature value.

Paragraph 32. A method according to Paragraph 30 or Paragraph 31, comprising
determining, if the two or more of the plurality of beams are all beams between the communications device and the RIS, that the one of the two or more of the plurality of beams associated with a lowest index is to be associated with that signature value.

Paragraph 33. A method according to any of Paragraphs 28 to 32, comprising
determining that the transmitted/received signals have a strength within a predetermined threshold of the highest strength when transmitted/received via at least one other of the plurality of beams.

Paragraph 34. A method according to Paragraph 33, comprising
determining that the at least one other of the plurality of beams is also to be associated with that signature value as a backup beam to the beam for which the transmitted/received signal has the highest strength for that signature value.

Paragraph 35. A method according to Paragraph 33 or Paragraph 34, comprising
determining, if the beam for which the transmitted/received signal has the highest strength for that signature value is a beam between the communications device and the RIS and the at least one other of the plurality of beams comprises the direct beam between the infrastructure equipment and the communications device, that the direct beam between the infrastructure equipment and the communications device is to be associated with that signature value instead of the beam for which the transmitted/received signal has the highest strength for that signature value.

Paragraph 36. A method according to any of Paragraphs 27 to 35, wherein the training phase is performed a plurality of times, wherein, during each of the times the training phase is performed, the communications device has a different geographic location.

Paragraph 37. A method according to any of Paragraphs 27 to 36, wherein the determining the plurality of possible signature values associated with the communications device is performed whilst maintaining a default configuration of the plurality of RIS elements.

Paragraph 38. A method according to any of Paragraphs 27 to 37, wherein the determining the plurality of possible signature values associated the communications device is performed a plurality of times, for each of a different configuration of the plurality of RIS elements, to produce a plurality of sets of the plurality of possible signature values.

Paragraph 39. A method according to any of Paragraphs 27 to 38, wherein the training phase is performed separately for downlink transmissions and uplink transmissions.

Paragraph 40. A method according to any of Paragraphs 27 to 39, wherein the determining the plurality of possible signature values associated with the communications device comprises performing a post-processing procedure on the plurality of possible signature values.

Paragraph 41. A method according to any of Paragraphs 27 to 40, wherein the steps of performing, for each of the plurality of signature values, measurements using each of the plurality of beams, and creating, based on the performed measurements, associations between the plurality of signature values and the plurality of beams, are only performed by the infrastructure equipment when a determined signature value is determined to be different to any previously determined signature values.

Paragraph 42. A method according to any of Paragraphs 27 to 41, comprising
determining that one of the determined signature values is the same as a previously determined signature value,
determining a second signature value, the second signature value being a different type of signature to the one of the determined signature values, and
creating, based on the performed measurements, the association between both the determined signature value and the second signature value and one of the plurality of beams.

Paragraph 43. A method according to any of Paragraphs 27 to 42, comprising
determining that one of the determined signature values is the same as a previously determined signature value,
creating, based on the performed measurements, the association between the determined signature value and the one of the plurality of beams,
determining that the previously determined signature value is associated with a different one of the plurality of beams to the determined signature value,
determining a second signature value, the second signature value being a different type of signature to the one of the determined signature values, and
creating, based on the performed measurements, the association between both the determined signature value and the second signature value and one of the plurality of beams.

Paragraph 44. A method according to any of Paragraphs 27 to 43, comprising, during the training phase, training a machine learning algorithm by matching, as an input to the machine learning algorithm, each of the determined signature values with, as an output to the machine learning algorithm, the associated beam of the plurality of beams.

Paragraph 45. A method according to any of Paragraphs 1 to 44, wherein the RIS comprises a plurality of RIS elements, and the controlling, by the infrastructure equipment, the configuration of the RIS comprises controlling, by the infrastructure equipment, a configuration of the plurality of RIS elements of the RIS.

Paragraph 46. A method according to any of Paragraphs 1 to 45, wherein the controlling, by the infrastructure equipment, the configuration of the RIS comprises controlling, by the infrastructure equipment, an amount by which the RIS is bent.

Paragraph 47. A method according to any of Paragraphs 1 to 46, wherein the controlling, by the infrastructure equipment, the configuration of the RIS comprises controlling, by the infrastructure equipment, an amount by which the RIS is rotated.

Paragraph 48. A method according to any of Paragraphs 1 to 47, wherein the controlling, by the infrastructure equipment, the configuration of the RIS comprises controlling, by the infrastructure equipment, a size of a reflection angle of the RIS.

Paragraph 49. A method according to any of Paragraphs 1 to 48, wherein the controlling, by the infrastructure equipment, the configuration of the RIS comprises controlling, by the infrastructure equipment, a focal length of the RIS.

Paragraph 50. A method according to any of Paragraphs 1 to 49, wherein the controlling, by the infrastructure equipment, the configuration of the RIS comprises transmitting signalling information to a RIS controller coupled to the RIS.

Paragraph 51. An infrastructure equipment forming part of a wireless communications network, the infrastructure equipment comprising
transceiver circuitry configured to transmit signals to and/or to receive signals from a communications device and/or to transmit signals to and/or receive signals from a reconfigurable intelligent surface, RIS, and
controller circuitry configured in combination with the transceiver circuitry, during an operational phase,
to determine a signature value associated with the communications device,
to select, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS, and
to transmit the signal to or to receive the signal from the communications device via the one or more selected beams.

Paragraph 52. Circuitry for infrastructure equipment forming part of a wireless communications network, the circuitry comprising
transceiver circuitry configured to transmit signals to and/or to receive signals from a communications device and/or to transmit signals to and/or receive signals from a reconfigurable intelligent surface, RIS, and
controller circuitry configured in combination with the transceiver circuitry, during an operational phase,
to determine a signature value associated with the communications device,
to select, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS, and
to transmit the signal to or to receive the signal from the communications device via the one or more selected beams.

Paragraph 53. A reconfigurable intelligent surface, RIS, comprising
a plurality of independently configurable RIS elements each configured to, in dependence on a configuration of that RIS element, re-radiate signals incident at that RIS element with a modified phase and/or a modified amplitude,
wherein the RIS is configured to re-radiate signals transmitted by an infrastructure equipment according to Paragraph 51.

Paragraph 54. A reconfigurable intelligent surface, RIS, controller coupled to a RIS according to Paragraph 53, the RIS controller configured to receive signals from and/or to transmit signals to the infrastructure equipment.

Paragraph 55. A method of operating a communications device configured to transmit signals to and/or to receive signals from an infrastructure equipment and/or to transmit signals to and/or receive signals from a reconfigurable intelligent surface, RIS, the method comprising, during an operational phase,
determining that one or more of a plurality of beams is to be used for the transmission of a signal between the infrastructure equipment and the communications device, each of the plurality of beams being associated with one of a plurality of possible signature values associated with the communications device, wherein at least one of the plurality of beams is a direct beam between the infrastructure equipment and the communications device and at least one other of the plurality of beams is a beam between the communications device and the RIS, and
transmitting the signal to or receiving the signal from the infrastructure equipment via the one or more selected beams.

Paragraph 56. A communications device comprising
transceiver circuitry configured to transmit signals to and/or to receive signals from an infrastructure equipment and/or to transmit signals to and/or receive signals from a reconfigurable intelligent surface, RIS, and
controller circuitry configured in combination with the transceiver circuitry, during an operational phase,
to determine that one or more of a plurality of beams is to be used for the transmission of a signal between the infrastructure equipment and the communications device, each of the plurality of beams being associated with one of a plurality of possible signature values associated with the communications device, wherein at least one of the plurality of beams is a direct beam between the infrastructure equipment and the communications device and at least one other of the plurality of beams is a beam between the communications device and the RIS, and
to transmit the signal to or to receive the signal from the infrastructure equipment via the one or more selected beams.

Paragraph 57. Circuitry for a communications device, the circuitry comprising
transceiver circuitry configured to transmit signals to and/or to receive signals from an infrastructure equipment and/or to transmit signals to and/or receive signals from a reconfigurable intelligent surface, RIS, and
controller circuitry configured in combination with the transceiver circuitry, during an operational phase,
to determine that one or more of a plurality of beams is to be used for the transmission of a signal between the infrastructure equipment and the communications device, each of the plurality of beams being associated with one of a plurality of possible signature values associated with the communications device, wherein at least one of the plurality of beams is a direct beam between the infrastructure equipment and the communications device and at least one other of the plurality of beams is a beam between the communications device and the RIS, and
to transmit the signal to or to receive the signal from the infrastructure equipment via the one or more selected beams.

Paragraph 58. A wireless communications system comprising an infrastructure equipment according to Paragraph 51 and a reconfigurable intelligent surface, RIS, according to Paragraph 53.

Paragraph 59. A wireless communications system according to Paragraph 58, further comprising a reconfigurable intelligent surface, RIS, controller according to Paragraph 54.

Paragraph 60. A wireless communications system according to Paragraph 58 or Paragraph 59, further comprising a communications device according to Paragraph 56.

Paragraph 61. A computer program comprising instructions which, when loaded onto a computer, cause the computer to perform a method according to any of Paragraphs 1 to 50 or Paragraph 55.

Paragraph 62. A non-transitory computer-readable storage medium storing a computer program according to Paragraph 61.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] Beixiong Zheng & Rui Zhang, “Intelligent Reflecting Surface-Enhanced OFDM: Channel Estimation and Reflection Optimization,” IEEE Wireless Communications Letters, vol. 9, no. 4, April 2020.

1. A method of operating an infrastructure equipment forming part of a wireless communications network, the infrastructure equipment being configured to transmit signals to and/or to receive signals from a communications device and/or to transmit signals to and/or receive signals from a reconfigurable intelligent surface, RIS, the method comprising, during an operational phase,
determining a signature value associated with the communications device,
selecting, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS, and
transmitting the signal to or receiving the signal from the communications device via the one or more selected beams.

2. A method according to claim 1, wherein the signature value is a channel estimation of a communications channel between the infrastructure equipment and the communications device.

3. A method according to claim 2, wherein the channel estimation is performed by the infrastructure equipment based on signals received by the infrastructure equipment from the communications device.

4. A method according to claim 3, wherein the signals, received from the communications device and based on which the channel estimation is performed by the infrastructure equipment, are reference signals and/or random access signals.

5. A method according to claim 2, wherein the channel estimation is performed by the communications device based on signals transmitted by the infrastructure equipment to the communications device.

6. A method according to claim 5, comprising
receiving, from the communications device, an indication of the channel estimation performed by the communications device.

7. A method according to claim 6, wherein the indication of the channel estimation performed by the communications device is carried in Uplink Control Information, UCI, received from the communication device.

8. A method according to claim 6, wherein the indication of the channel estimation performed by the communications device is received in a Physical Uplink Control Channel, PUCCH, from the communication device.

9. A method according to claim 6, wherein the indication of the channel estimation performed by the communications device is received as a quantized indication of the channel estimation.

10. A method according to claim 5, wherein the signals transmitted by the infrastructure equipment to the communications device for the communication device to perform the channel estimation are channel state information reference signals and/or demodulation reference signals.

11. A method according to claim 1, wherein the signature value is a measured strength of one or more signals received by the communications device from the infrastructure equipment and/or measured strength of one or more signals received by the communications device from one or more other infrastructure equipment.

12. A method according to claim 11, comprising
receiving, from the communications device, a measurement report comprising an indication of the measured strength of the one or more signals received by the communications device from the infrastructure equipment and/or the measured strength of the one or more signals received by the communications device from the one or more other infrastructure equipment.

13. A method according to claim 11, wherein the signature value is the measured strength of the one or more signals received by the communications device from the one or more other infrastructure equipment relative to the measured strength of the one or more signals received by the communications device from the infrastructure equipment.

14. (canceled)

15. A method according to claim 1, wherein the signature value is a measured strength of one or more sidelink signals received by the communications device from one or more nodes of the wireless communications network.

16. (canceled)

17. A method according to claim 1, wherein the signature value is associated with a time of arrival at the communications device of signals received by the communications device from the infrastructure equipment and/or signals received by the communications device from one or more other infrastructure equipment.

18.-20. (canceled)

21. A method according to claim 1, wherein the signature value is a geographic location of the communications device.

22. A method according to claim 1, wherein the signature value is a set of samples taken by the infrastructure equipment based on signals received by the infrastructure equipment from the communications device.

23. A method according to claim 1, wherein the signature value is a set of samples taken by the communications device based on signals received by the communications device from the infrastructure equipment, and the method comprises
receiving, from the communications device, an indication of the set of samples.

24.-50. (canceled)

51. An infrastructure equipment forming part of a wireless communications network, the infrastructure equipment comprising
transceiver circuitry configured to transmit signals to and/or to receive signals from a communications device and/or to transmit signals to and/or receive signals from a reconfigurable intelligent surface, RIS, and
controller circuitry configured in combination with the transceiver circuitry, during an operational phase,
to determine a signature value associated with the communications device,
to select, based on the signature value, one or more of a plurality of beams for the transmission of a signal between the infrastructure equipment and the communications device, each of the plurality of beams being associated with one of a plurality of possible signature values, wherein at least one of the plurality of beams is a direct beam between the infrastructure equipment and the communications device and at least one other of the plurality of beams is a beam between the communications device and the RIS, wherein each of the at least one of the plurality of beams between the communications device and the RIS are generated at the RIS through controlling, by the infrastructure equipment, a configuration of the RIS, and
to transmit the signal to or to receive the signal from the communications device via the one or more selected beams.

52.-55. (canceled)

56. A communications device comprising
transceiver circuitry configured to transmit signals to and/or to receive signals from an infrastructure equipment and/or to transmit signals to and/or receive signals from a reconfigurable intelligent surface, RIS, and
controller circuitry configured in combination with the transceiver circuitry, during an operational phase,
to determine that one or more of a plurality of beams is to be used for the transmission of a signal between the infrastructure equipment and the communications device, each of the plurality of beams being associated with one of a plurality of possible signature values associated with the communications device, wherein at least one of the plurality of beams is a direct beam between the infrastructure equipment and the communications device and at least one other of the plurality of beams is a beam between the communications device and the RIS, and
to transmit the signal to or to receive the signal from the infrastructure equipment via the one or more selected beams.

57.-62. (canceled)
